(19) United States
(12) Patent Application Publication
(10) Pub. No.: US 2008/0252552 A1
(43) Pub. Date: Oct. 16, 2008

(54) Antenna Housing and Antennas with Such Antenna Housings

(76) Inventors: Uhland Goebel, Wila (CH); Peter Nuechter, Stein (CH)

Correspondence Address: MOETTELI & ASSOCIATES SARL, ST. LEONHARDSTRASSE 4, ST. GALLEN, CH-9000, CH

(21) Appl. No.: 11/569,583

(22) PCT Filed: May 27, 2005
(86) PCT No.: PCT/EP2005/005756

§ 371 Date: Mar. 11, 2008

(30) Foreign Application Priority Data
May 28, 2004 (EP) 04012693.0

(51) Int. Cl. H01Q 1/42

(52) U.S. Cl. 343/872

(57) ABSTRACT

Antenna (10) with several radiating elements (14). The antenna (10) comprises a back wall (11), which is made of composite materials and acts as a carrier for the internal elements a) and b) of the antenna (10). A radome (12), which consists of a thin, hard shell, serves as a cover, which can be connected with a connecting area of the back wall (11), so as to form housing together with the back wall (11). Additionally a foam core (15) is provided in the antenna. The following elements of the antenna are hermetically protected in the antenna housing:

a) one or more radiating elements (14), and

b) a circuit board (13) for receiving the radiating elements (14).

The present invention refers to antenna housings and antenna arrangements.

The radiation elements of a single or a group or antennas are

usually fastened to a stable frame or hex structure, whereby this structure serves at the same time as carrier for the different elements of the antennas end provides the necessary mechanical stability to the antenna.

It is a problem of known antennas that they are expensive and heavy. in addition the assembly of the antennas and the attachment to a transmitting pole or a building are inconvenient. A further disadvantage of known antennas is the fact that they are nor suitable for a simple and reliable mass production. This is a particularly important point, if the manufacturing is to be carried out by untrained persons.

Based on the state of the art the object of the invention is to create an antenna housing and antennas with such antenna housings which are simple, economical and nevertheless provide the necessary firmness.

It is a further object of the invention to provide a group antenna comprising a number of dipole antennas.

in accordance with the invention an antenna is provided with one or more radiating elements according to claim 1. The antenna housing comprises a (back) wall made of composite materials and is designed for supporting the internal antenna elements. A radome, which comprises a thin, hard RF or HF suitable shell, serves as a kind of cover, which can be connected with a connecting area of the (back) wall in order to form together with the (back) wall the antenna housing. Between the (back) wall and the radome a RF or a HF suitable foam core is fitted. The following antenna elements are hermetically protected in the antenna housing:

a) one or more radiating elements,

b) a circuit board with a control circuit for the suspension of the radiating elements.

in accordance with the invention an antenna is provided with one or more radiating elements according to claim 18. The antenna comprises a (back) wall made of composite materials and is appropriate for supporting all antenna elements. A radome, which comprises a thin, hard, RF or HF suitable shell, serves as a cover, which can be connected with a connecting area of the (back) wall in order to form together with the (back) wall the antenna housing. Between the (back) wall and the radome a RF or a HF suitable foam core is fitted. The following elements of the antenna are hermetically protected in the antenna housing:

a) one or more radiating elements,

b) a circuit board with a control circuit for the suspension of the radiating elements.

Further embodiments of the invention are to he inferred from the dependent claims 2 to 17 and 19 to 24.

The invention is described in detail in the following based on the following figures. Symmetry planes are indicated in the drawings by broken lines and imaginary surfaces by dotted lines, where this is necessary far the clearer representation of the invention. These figures depict:

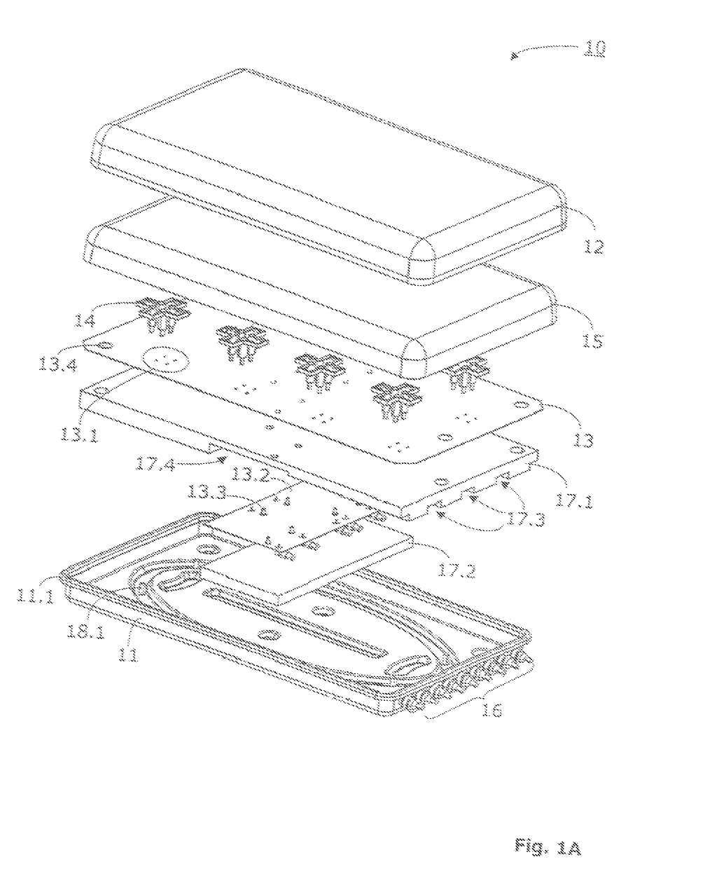

FIG. 1A a (group) antenna in accordance with invention in a schematic exploded view;

PIG. 1B the (group) antenna in accordance with FIG. 1A in an other exploded view;

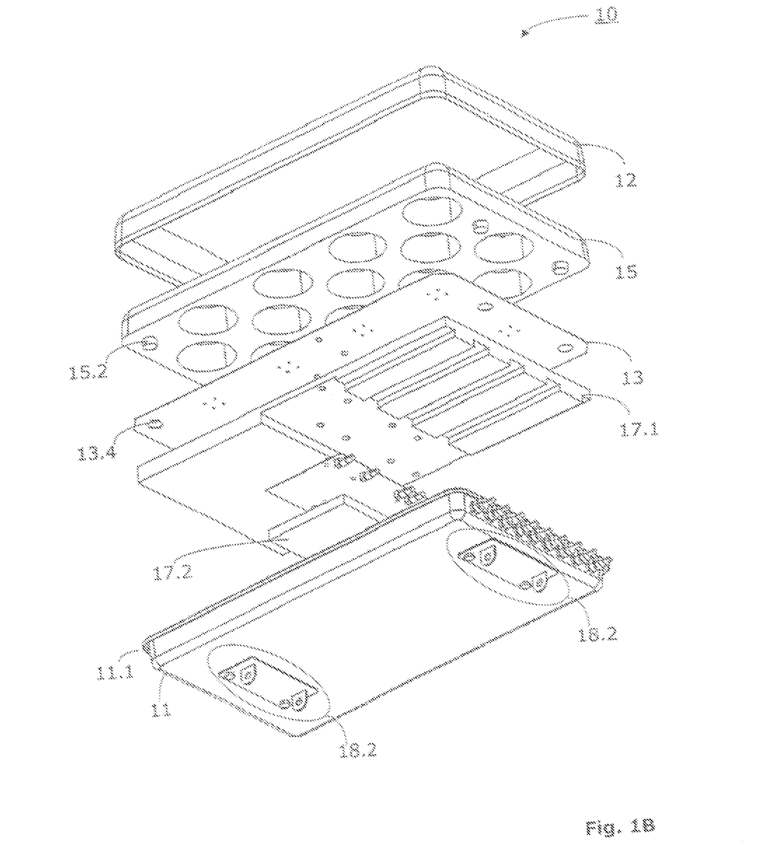

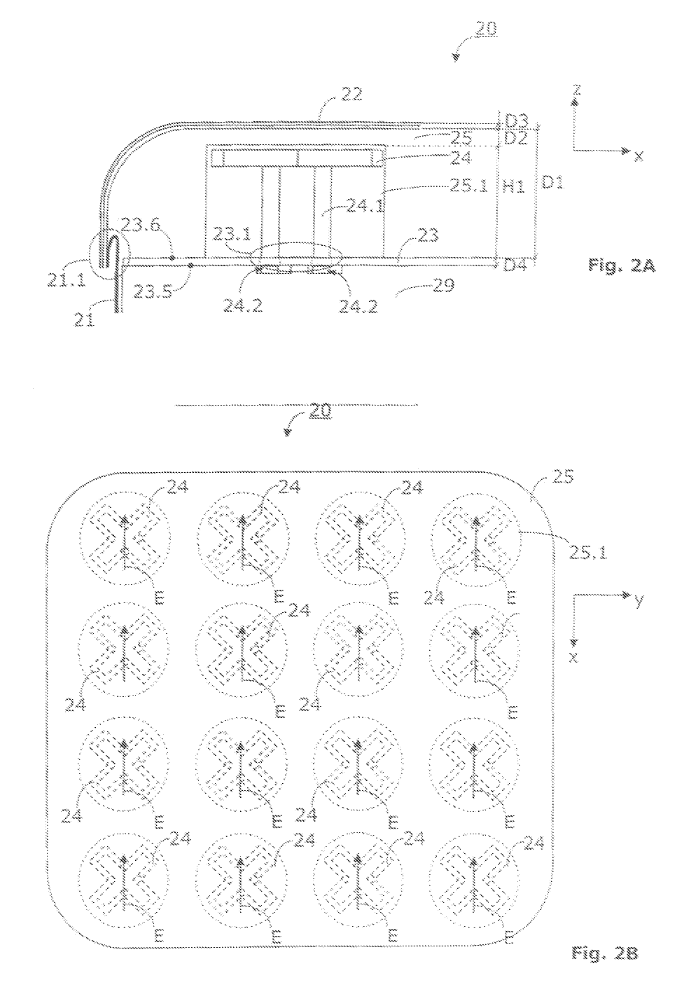

FIG. 2A a schematic section through a part or a further antenna in accordance with invention;

FIG. 2B the antenna in accordance with FIG. 2A in a top view:

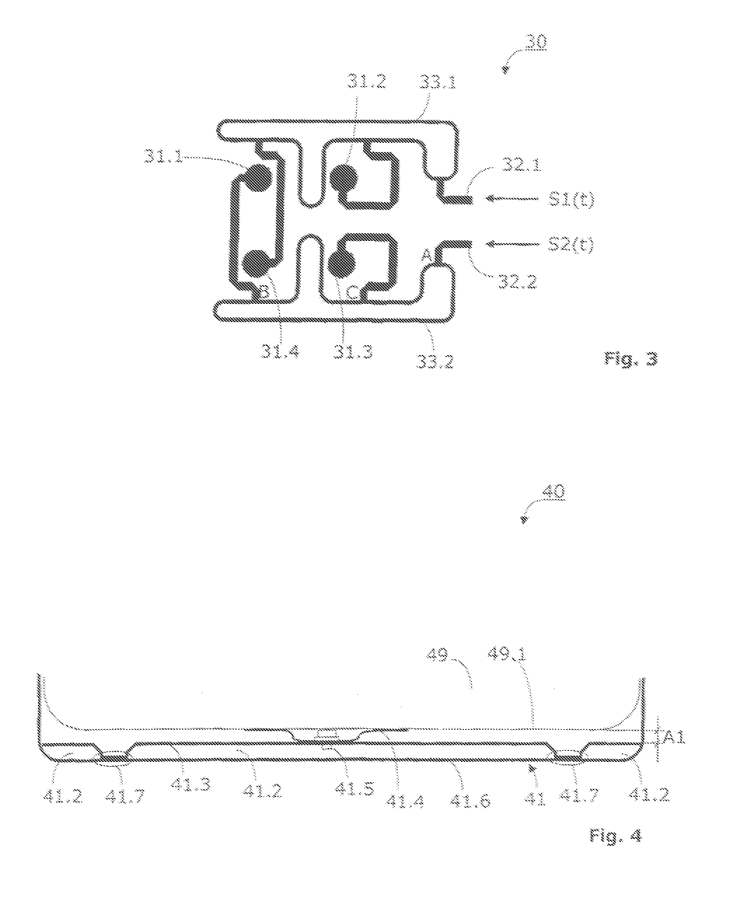

FIG. 3 view of a part of a control circuit, in accordance with the invention;

FIG. 4 a schematic section through a part of a further antenna in accordance with invention;

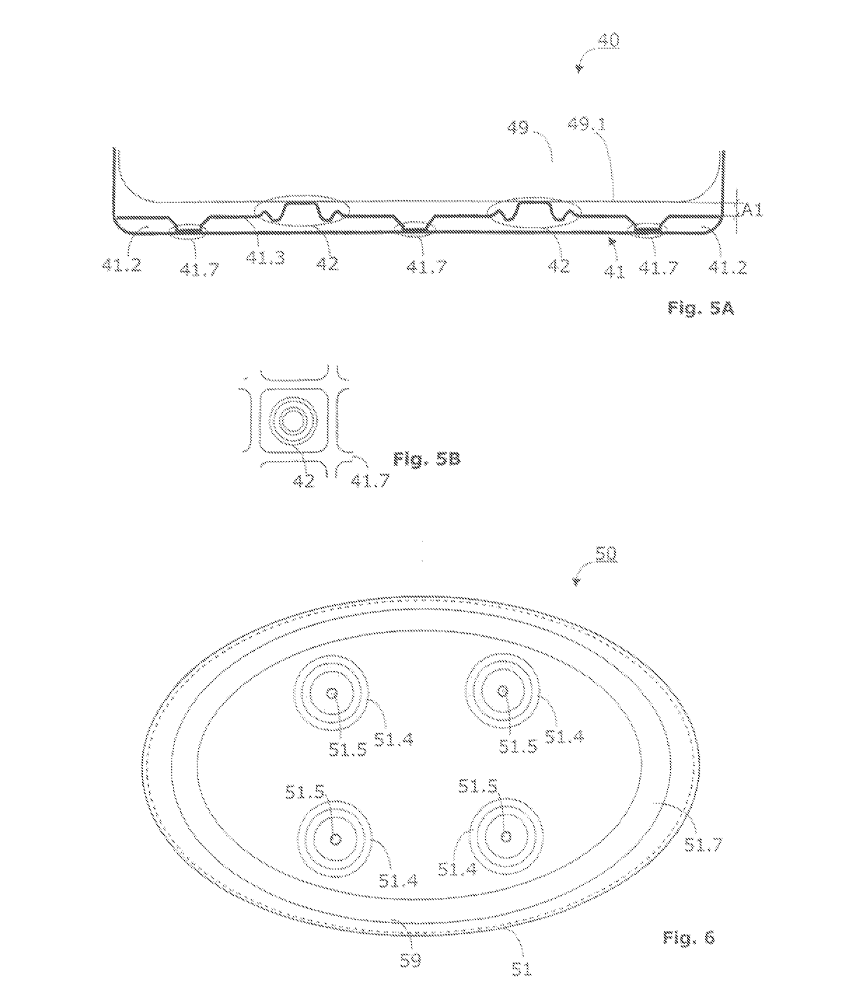

FIG. 5A a schematic section through a part of a further antenna in accordance with invention;

FIG. 5B a schematic top view of an antenna from the range shown in FIG. 5A;

FIG. 6 a schematic top view of a further antenna in accordance with invention.

### DETAILED DESCRIPTION

In the following terms are described and defined, which appear several times in the description and the patent claims.

As wall or back wall, an element is denominated which is in the rear area of an antenna housing or an antenna and is usually provided with means for mounting, in order to fasten the antenna housing on a pole or a building. The terms in front, in the back, above, below and further indications of direction are used in the description, in order to be able to describe the individual elements of an antenna in reference to the instated condition more easily, without these terms limiting the scope of protection.

A radome is a kind of cover, which is typically situated in front of the antenna arrangement and sits in the receiving or sending area of the antenna. In order not to affect the transmitting end/or receiving characteristics of the antenna arrangement, the radome is typically made of materials that are not or little absorbing. In other words, the radome comprises materials, which are RF or HF suitable. The same applies to other components (for example the still to he described from core) of the antenna housing and their materials, at least those that are situated in the transmitting and/or receiving areas of the antenna.

The following text addresses radiating elements. It preferably concerns three-dimensional radiating elements, which consist for example of a cast part. But planar emitters can also be used in an antenna according to the invention.

In accordance with invention the term cast parts is to be understood as form parts, which are manufactured by the (automatic) injection molding process. Thereby thermoplastic materials are processed by means of an injection molding process. Instead of plastic, metals can also be used for manufacturing the cast parts. The form parts are characterized in that a minimum of finishing work is necessary. In addition the dimensions of the form parts are very precise. Further details regarding three-dimensional radiating elements can be inferred from the Swiss patent application with title “Breitbadn-Antenne mit einem 3-dimensionalen Gussteil”, which was filed on 23 Dec. 2002 under the application number 2002 2210/02.

Reflectors can be used, which preferably comprise a conducting surface. This conducting surface can be connected to ground. The reflecting surface can be flat or curved. In accordance with invention preferably a metallized side of a circuit board is used as reflector.

Depending upon the embodiment of the antenna a control circuit can comprise parts of a receiver and/or transmitter, e.g. polarization switches, amplifier stages or calibration elements.

A first antenna 10, according to the invention, is shown in the FIGS. 1A and 1B. An antenna 10 according to the invention comprises a back wall 11, which is made of composite materials and is designed to support elements of the antenna 10 (called herein antenna elements). The front side of the antenna 10 is featured by a radome 12, which serves as thin, hard, RF or HF suitable shell, which like a cover can be connected with a circumferential connecting area 11.1 on the (back) wall. In the installed condition, the radome 12 together with the back wall 11 form an antenna housing for the different antenna elements. Within this antenna housing the elements described below are arranged.

A circuit board 13 with an integrated control circuit carries several radiating elements 14. The control circuit is not visible in the FIGS. 1A and 1B. It is preferably situated on the back of the circuit board 13. On the circuit board 13 connecting regions for receiving the radiating elements 14 and for providing an electrically conducting connection of the radiating elements 14 with the control circuit are provided. In FIG. 1A such a connector is designated with the reference number 13.1. The front surface of the circuit board 13 (visible on FIG. 1A) is preferably completely metallized and exhibits holes or recesses only in the connecting regions 13.1, in order for the radiating elements 14 and the control circuit on the back of the circuit board 13 to be connected.

For the tension-free production of the circuit board it can be favorable to provide the metal surface with a multiplicity of regular recesses with dimensions so small in the comparison to the wavelength so that they do not have substantial influence on the electrical behavior of the antennas. For production engineering reasons the circuit board can be divided for example into several circuit boards.

In the shown example of the invention, each radiating element 14 has four legs. Each of the hour legs is put into a hole in the circuit board 13 and connected with the control circuit on the back side. A plug connection can be provided, which does automatically not only provide mechanical connections of the radiating elements 14 with the circuit board 13, but it also creates the electrical connection to the control circuit.

In the shown example of the invention eight radiating elements 14 in two columns with four radiating elements each 14 are arranged next to each other. The antenna 10 thus concerns a so-called group antenna.

A further a component of the invention is a foam core 15, which is provided in the present example with recesses 15.1 for the receiving of the three-dimensional radiating elements 14. In FIG. 1B more recesses 15.1 are shown than would really be necessary. If possible, the foam core 15 has as many recesses 15.1 as many radiating elements 14 the antenna 10 has. In addition, for production engineering or weight reasons a larger number of recesses can be provided. It is important that where the foam core 15 has no recesses 15.1, i.e. in the space of the lands between the recesses 15.1, it rests at least in partial lamination on the front sloe of the circuit board 13. In addition it is important that the foam core 15 at least in the transmitting or sending area of the antenna 10 it is designed so that it is RF or HF-suitable.

In the FIGS. 1A and 1B further optional elements are shown, which are described in the following. As can be recognized, the back wall 11 comprises a set of connecting devices 16, which serve as an electrical connection between the control circuit and external electronics, for example an amplifier. The connecting devices 15 can be differently implemented and differently arranged. So-called flange connectors are particularly suitable as connecting devices 16, which can be seen in FIGS. 1A and 1B. The interior part of the flange connectors can be soldered to a cable, which leads for example from the connector to the control circuit. A flange connector is for example put from the inside through a hole in the back wall (or sidewall) 11 and screwed together from the outside with a nut (glued, press-fitted).

An optional roam boo 17 is provided, that in the example shown comprises of a larger part of 17.1 end of a smaller part 17.2. The optional foam bed 17 essentially ensures that a flat contact surface is provided for the circuit board 13 and/or for a further circuit board 13.2. In order to accomplish this, the part 17.1 is provided with recesses 17.3 for cables and a recess 17.4 for the further circuit board 13.2. The front of the foam bed 17, i.e. that side, which is oriented towards the circuit board 13, is preferably flat.

In the example shown in the homes 1A and 1B optional pins 15.2 are present on the foam core 15. The pins 15.2 can have a cylindrical or conical form to give to the circuit board 13 an exactly defined lateral position. For this purpose the circuit board 13 can be provided with holes 13.4.

In FIG. 1A it is to be recognized, as previously mentioned, that in addition to the circuit board 13 a further circuit board 13.2 is provided. This further circuit board 13.2 is preferably smaller than the circuit board 13 and can mounted onto the circuit board 13 by means of plug connectors 13.3. Preferably the plug connectors 13.3 are laid out in such a way that they provide both a mechanical and an electrical connection between the circuit board 13 and the further circuit board 13.2, Suhner® MMBX connectors from Huber°Suhner are particularly suitable, as these connectors are able to adjust to certain tolerances without interrupting the electrical connection.

As shown by the FIGS. 1A and 1B, a new stable and compact antenna housing with a layered structure results. The layered structure is laid out in such a way that there is no or very little room for movements for the individual antenna elements. The back wall 11 is specially formed, in order to give the entire antenna 10 torsion rigidity and mechanical stability. Depending upon mounting, the back wall 11 must additionally be laid out so that it is able to withstand the enormous wind forces, which affect the entire antenna 10. The elements of the antenna can be protected against inadmissible mechanical loads only by a special layout of the back wall 11.

Preferably, the back wall 11 comprises connecting pieces or spline nuts 18.1, which makes it possible for the flanges 18.2, brackets or tongues to be fastened to the exterior of the back wall 11. In a particularly stable embodiment, which is used for example in case of particularly large surface antennas, the back wall 11 can be reinforced on the inner side by metal strips or other elements, that better guide forgoes and forces into the back wall 11.

In a preferred embodiment of the antenna, the radiating elements 14 are provided with fastening elements at the lower end, that allow the radiating elements 14 to be fastened to the circuit board 13. For this purpose snatching mechanisms or plug connectors can be used as fastening elements, which make it possible to insert and lock the radiating elements 14 into holes 13.1 of the circuit board 13. Instead of a snatching mechanisms screw-, solder- or others means for connection can also be used. Connections, which also make an electrical connection beside the mechanical connection, are ideal.

When connecting the radiating elements 14 with the circuit board 13 it is to be considered that the front of the circuit board 13 can be metallized, in order to serve as reflector. The fastening elements must be implemented at least partially so that they do not form an electrical connection to the conductive side of the circuit board 13. Otherwise both fastening elements would be short circuited by the metallic side of the circuit board 13 and the antenna 10 could not be driven.

In the FIGS. 2A and 2B a further antenna 20 is shown according to the invention. FIG. 2A shows a cross section of a part of the antenna 20. The layered structure is described in the following from bottom to top (respectively from the back to the front). The back wall 21 has a circumferential side panel, which runs essentially perpendicular to the surface, which is spanned by the x and the y axis. This surface is also called x-y surface. In FIG. 2A only a part of the left side panel of the back wall 21 is visible. Towards the top, the side panel of the back wall 21 closes with a kind of fold 21.1, as indicated in FIG. 2A. In the FIGS. 1A, 1B, 2A and 2B this fold is preferably implemented as a circumferential fold, but this is not absolutely necessary. In the area of the fold 21.1, the back wall 21 and the radome 22 are welded or glued together. For example a roll seam welding procedure can be used, in order to weld the radome 22 with the back wall 21. With this welding method the surfaces to be welded are warmed up and connected by ultrasound. The back wall 21 together with the radome 22 forms an antenna housing, which encloses the elements of the antenna. The following elements of the antenna are shown in FIG. 2A: foam bed 29, circuit board 23, radiating element 24 and foam core 25. The foam bed 29 rests on the back wall 21 and holds on the front the circuit board 23. Preferably recesses are provided in the foam bed 29, in order for example to accommodate the lower ends 24.2 of the supports 24.1 of the radiating elements 24. The foam bed 29 can additionally or alternatively contain recesses for cables etc. The circuit board 23 features on the back 23.5 a control circuit or a part of a control circuit. The entire surface of front 23.6 of the circuit board 23 is provided with a metal layer. The control circuit and the metal layer are not visible on FIG. 2A and FIG. 2B. In the area 23.1 the circuit board 23 is provided with recesses, in order to accommodate the lower ends 24.2 of the supports 24.1 of the radiating elements 24. In the area of the lower ends 24.2 connections can be arranged or constructed for example, which also make an electrical connection beside the mechanical connection.

In the foam core 25 there are several recesses 25.1 as one can see in FIG. 2A. The radiating element 24 sits in this recess 25.1. The foam core 25 fills the space between the front 23.6 of the circuit board 23 and the back, respectively the inner side of the radome 2.2. Preferably, no gap or distance exists between the too side of the foam core 25 and the radome 22. The relatively flexible and thin radome 22 as such is essentially supported over the entire X-Y surface by the foam core 25.

According to the invention the foam core 25 preferably has a thickness D1 between 1 cm and 20 cm. The thickness D1 is essentially determined from the height of H1 of the radiating elements 24, if three-dimensional radiating elements 24 are used, and from the thickness D2 of the part of the foam core 25, which is above the radiating elements 24. As shown in FIG. 2A, in the shown example D1=H1+D2. At least the pant of the foam core 25 above the radiating elements 24 most be embodied RF or HF-suitably.

The circuit board 23 typically has a thickness D4 between 50 μm and 2 mm. Preferably, the circuit board is 250 μm thick. The radome 22 preferably has a thickness D3 between 0.5 mm and 5 mm, preferably between 1 and 2 mm. In the preferred embodiment the radome 22 and also the circuit board 23 are so thinly laid out that by themselves they do not provide sufficient mechanical stability for an antenna. Only by the novel use in a new layer-like structure, the entire antenna gets a sufficient stability.

According to the invention the control circuit can be used to supply the radiating elements. For this purpose the control circuit can comprise a network, which connects supply inputs with the radiating elements in such a way that they can be driven with the desired phases.

A group antenna in accordance with invention is characterized in that several radiating elements are arranged in rows and columns. The radiating elements 24 of the antenna 20 are in the layout shown in FIG. 2B turned by 45 degrees.

In FIG. 2B a top view of the radome 22 of the antenna 20 is shown, whereby the position of the radiating elements 24 is indicated by broken lines. There are provided altogether four columns with four radiating elements 24 each. Each of the sixteen radiating elements 24 sits in its own cylindrical recess 25.1 of the foam core 25. In the example shown the individual radiating elements 24 are driven so that at each radiating element 24 an E-field results, which is directed counter parallel to the x axis. Thus an E-field results, which is linearly polarized in a negative x-direction (vertical polarization).

The radiating elements can be differently driven. Depending upon control for instance circular, elliptical polarizations, or Slant polarizations can be obtained.

A part of a control circuit 30, in accordance with the invention, is shown in FIG. 3 as an example. It shows the control circuit 30 as a network, which is situated on the back side 23.5 of the circuit board 23 and comprises two supply inputs 32.1 and 32.2. Four ports 31.1 to 31.4 are provides, which are in connection with the fastening elements (not visible on FIG. 3) of the radiating element 24. Between the supply input 32.1 and the two ports 31.4 and 31.2 a 180 °-Hybrid 33.1 is arranged. Between she supply input 32.2 and the two ports 31.3 and 31.1 a further 180 °-Hybrid 33.2 is arranged. The 180°-Hybrid 33.2 comprises a delay line between the points A and C as well as e further delay line between the points A and B. The circuits between B and C again represents a delay line. Ports 31.1 to 31.4 are connected by circuit segments with the two 180°-Hybrids 33.1 and 33.2, which each cause the same phase shift. The network 30 guarantees that each of the diagonally opposing ports, which are driven 180° phase shifted, that is out of phase, whereby the two remaining ports lay in a virtual short-circuit plane, respectively. The supply inputs 32.1 and 32.2 feature thereby a high mutual decoupling. Due to this one obtains a particular clean polarization of the emitted wave, respectively a strongly suppressed cross-polarization component.

Different embodiments of the 180°-power dividers are also possible.

If one now feeds the supply input 32.2 with a HF-signal S2(t), then a signal with the phase position 00 appears at the port 31.1 and a signal with the phase position 1800 at the port 31.3. With the network 30 shown one can thus produce an push pull signal from a HF-signal S2(t). The radiating element with the described supply builds up a +45° Slant polarization. Alternatively, the exclusive supply of the supply input 32.1 produces at the radiating element a −45° Slant polarization.

(The designation of the polarizations only applies, if the arrangement of FIG. 3 is aligned accordingly in the x-y direction. In the arrangement on FIG. 2B slant and horizontal/vertically are “exchanged” again).

If one now feeds for example the supply input 32.1 with a HF-signal S1(t) and the supply input 32.2 with a HF-signal S2(t), which are both in-phase with respect to each other, then at the gate 31.2 there is a signal with the phase position 0°, at the port 31.3 a signal with the phase position 0°, at the gate 31.4 a signal with the phase position 180 ° and at the gate 31.1 a signal with the phase position 180° appears. With the network 30 shown one thus can produce an antiphase signal from two HF-signals S1(t) and S2(t). The radiating element develops with the described supply a horizontal polarization.

If one dozes the supply inputs 32.1 and 32.2 antiphase (i.e. S1(t) is out of phase with respect to S2(t) by 180°), then a vertical polarization develops itself, like in the example shown in FIG. 2B.

In order to obtain circular polarization, the two supply inputs 32.1 and 32.2 are supplied in such a way that S1(t) is out of phase by +90° or −90° with respect to S2(t). Beyond that, elliptical polarizations can be produced, if with a +90° or a −90° phase shift the amplitude of S1(t) is different from the amplitude of S2(t) and/or the phase shift deviates from 0°, +90°, −90° and 180°.

It is an advantage of the exemplarily shown network 30 that the polarization characteristics of the antenna elements are adjustable by a suitable control only without change of the radiation element. Depending upon supply at the supply inputs, thus the polarization of the signals radiated by the radiating elements is influenceable.

The control of the radiating elements also can take place by other supply circuits, for example (combination) networks and delay lines. The supply circuit can be implemented in planar, coaxial or waveguide technology.

The supply circuit can be laid out so that out of a signal (e.g. S1(t)) one is able to generate up to four different supply signals for driving the radiating elements.

Details of a further antenna 40 are shown on FIG. 4. In this figure only the lower, respectively rear range of an antenna 40 is shown. FIG. 4 shows a schematic section through the back wall 41 and a part of a foam bed 49. The beck wall 41 is, in order to guarantee necessary stability with justifiable weight, made of two layers 41.6 and 41.3. Between these layers 41.6 and 41.3 there are cavities 41.2. In the areas 41.7 the two layers 41.6 and 41.3 are connected to each other. Soon a connection can be made for example by welding or gluing together. In the example shown only the back wall 41 is implemented in double or multiple layers. It is also possible to pull up the double or multi-layerness into the area of the vertical side panels.

It is now possible to insert a foam core 49 during the assembling of the antenna 40 in such a way that it come to lay directly on the layer 41.3 of the back wall 41. Since in the course or the time consolidation occurrences, contractions or shifts within the assembled antenna housing may appear, it is favorable if means are used to compensate such alterations/changes. In addition during wind forces or other vibrations, displacements within the antenna housing may appear. For this reason additional means are necessary, which help to avoid this.

In FIG. 4 a first possible solution is shown, which is particularly advantageous. A gap of the thickness A1 between at least one area of the layer 41.3 of the back wall 41 and the rearward side 49.1 of the foam bed 49 is provided. Within the region of this gap means are arranged to exercise a certain contact pressure on the foam bed 49. As FIG. 4 shows, a spring element 41.4 can be used for example, which like a sort of a sheet or diaphragm spring exercises a contact pressure. The spring element 41.4 is fastened in such a way to the back wall 41 with blind rivets 41.5 that it is not visible from the outside. The lower end of the blind rivets 41.5 projects into the gap 41.2. The spring element 41.4 itself can be disc shape or bar shape designed, whereby in the example shown the ends of the bar shape design or “the disc edge” of the disc shape design press against the foam bed 49. In addition, there are other elements, which exercise a spring force and ensure the contact pressure on the foam bed 49. With a separate sheet or diaphragm spring element 41.4, as shown in FIG. 4, blind rivets are not absolutely necessary, but might be helpful however during assembling. There are also different possibilities to provide sheet or diaphragm spring elements.

In the FIGS. 5A and 5b, a part of a farther particularly favorable solution is shown. In these two figures the same reference symbols are used as in FIG. 4, even if the solutions differ in details. The back wall features spring bellows 42, which are integrated into a composite plate 41.3. FIG. 5B shows a partial view of one of the spring bellows 42 in top view.

Preferably in the range of the rearward sloe 49.1 the foam bed 49 can be compressed or coated, so the contact pressure can be better distributed and induced. That applies also to the foam bed of the other embodiments.

In FIG. 6 a further antenna 50 is shown. The antenna housing (comprising a radome, a foam core and a back wall) has an oval form. A top view of the inside of the Pack wall 51 is shown. The back wall 51 is, as in FIG. 4, implemented in multiple layers and has an area 51.7, within which the layers are connected with each other. In the top view, the area 51.7 has an oval form and is constructed in form of a groove or a recess. In the example shown four spring elements 51.4 (spring plates or spring bellows) are provided, which are fastened to the back wall 51 with rivets 51.5, screws or other means. The spring elements 51.4 can be also glued, welded or pressed on. It is for example favorable to provide the back wall 51 with studs onto which the spring elements 51.4 can be pressed. But the spring elements can also be integrated directly into the back plate, as described on the basis of FIGS. 5A and 5B. A foam bed 59, that is illustrated in FIG. 6 by a dotted outline, rests on the spring elements 51.4.

The beck wall, according to the invention, of the different embodiments features at least a thermoplastically formed plate (layer), which preferably comprises polypropylene, PP or Polyetherimid as material. In a further preferred embodiment, the back wall comprises of a composite material, preferably CFK, GFK or a KFK.

In order to provide stability to the back wall, it is preferably implemented in two or multiple layers. By connecting (welding or gluing) the two or more layers, respectively plates (for example plates 41.3 and 41.6), the required rigidity is provided to the back wall. One of the plates (for instance plate 41.6) preferably is a plate deformed by deep drawing. This plate can be made of one or more deep-drawing foils, which are for example reinforced.

According to the invention the back wall serves in all embodiments as hard shell, which provides stability to fire entire antenna by distribution of the suspension forces (wind load) and by improving the twisting rigidity.

According to the different embodiments of the invention, the radome is preferably made of one or more foils in a forming tool. The radome is actually thin and barely torsionally stiff. To a particularly preferred embodiment the external side of the radome is water-repelling and/or weather-resistant and/or UV stabilized. This is particularly favorable, since otherwise with durable UV irradiation the radome can become brittle. The water-repelling characteristic is important, since water crops can affect the radiation or receiving characteristics of the antenna. This is particularly important with antennas, which radiate within the Gigahertz range (e.g. 60 GHz). As important characteristic of these radomes, however, is regarded that these comprise RH or HF—suitable materials at least in the receiving or transmitting sections.

For example the radome comprises Tedlar® (from the company DuPont) and/or Kynar® (from the company ATOFINA). In order to make it harder (in the sense of shatterproof) the radome can be provided with glass fibers or Kevlar fibers. PPS can be also used as deep-drawing foil. Alternatively the radome foil can be also laid out as multi-layer system, for example a combination of Liquid Crystal Polymer (LCP) of the company DuPont with Tedlar®. In another case a multi-layer system can serve as a radome, which consists of a prefabricated, thin planar foam body, which is covered with a foil, where this is plastically shaped.

In a preferred embodiment e plastic foil, which later serves as a radome, is inserted into a forming fool before the foam core expands. Thereby the radome foil can be connected with the foam core. This procedure can be used with all embodiments described.

It can be advantageous to thereby insert a separating foil in order to make possible a later single-variety separation of radome foil and foam core.

The inside of the radome can be possibly coated. in order to obtain a mechanical connection with the foam core.

Preferably the outer skin of the radome can be color designed, in order to enable an inconspicuous mounting on a pole or a building. It is also conceivable to varnish the radome if the varnish is applied thinly enough. Also an optional auxiliary coating can be laid on for the improvement of the hydrophobic characteristics.

These different variants and modifications of the radome can be used with all described embodiments.

For example the fold is a circumferential fold (see for example 21.1) of the back wall, which is constructed so that after assembling it presses the circuit board against the foam core.

The fold is preferably arranged in such a way that the seam developing upon sealing is exposed only to a tangential shearing force.

Preferably the area of the radome and the area of the back wall, which are to be welded with one another are material-homogeneous, that is in the contact area of the two parts consist of the same materials.

In accordance with invention the foam core should be laid out so that it stabilizes the radome and thereby a light, torsionally stiff arrangement results.

Preferably the foam core and/or the foam bed comprise a thermoplastic polymer. This thermoplastic polymer is preferably selected from the group polystyrene and its copolymers, polyvinyl chloride, Polyether PU, polyester PU, Polypropylene, polyethylene or polymethyl metacrylate (PMMA) or Polymethacrylimid (PMI), e.g. Rohazell from the company Röhm, since these materials possess one or several of the following characteristics:

easily producible in large quantities,

economical,

small density,

producible with thin-walls,

form/dlmenslon-stable (small contraction, respectively dimensionally stable),

loadable,

isolating,

humidity-water-proof,

RF or HF suitable (i.e. small or no absorption),

none or only small release of humidity or wafer.

The foam core and/or the foam bed can be formed by extruding, injection molding, mold casting, the RIM procedure (reaction injection molding) or by the RRIM procedure (reinforced reaction injection molding). With the well-known RIM and RRIM procedures the plastic monomers react with their hardener/cross linking agent under the influence of temperature.

The foam core can be fiber-reinforced, preferably glass-fiber reinforced, if additional stability must be given to it. This is particularly preferred, when because of space restrictions only a relatively thin foam core can be used. Depending upon application and embodiment, the foam core can also have a multilayered or a multi-zoned structure.

In a preferred modification of the different hitherto described embodiments, the team core and/or the foam bed has a pressure resistant surface or a layer is provided, which gives a pressure resistant surface to the foam material. The foam material can be also modified so it is flame-retardant.

The foam core and, if available, the foam bed serve as mechanical spacers of the antenna elements and improve at the same time the rigidity of the entire antenna. In addition they absorb mechanical oscillations.

According to the invention a metallic shielding arrangement can be provided, that is connected completely, partially or not at all with a conducting reflector surface 23.6-—for example reflector surface 23.6. The shielding arrangement preferably features the same symmetry planes as the radiating element surrounded by it. It can be made up of one piece or considering the symmetry planes, made up from an appropriate number of individual elements. A particularly favorable arrangement consists of a circumferential electrically conducting wall, which ends depending upon desired beam focusing underneath or above the furthest point of the radiating elements 24 turned away from the reflector surface 23.6. The shielding arrangement can be used beyond that, in order to reduce the mutual coupling between neighboring radiating elements in a group antenna. Each of the described embodiments can be modified by a shielding arrangement.

The radiating elements however can have other orientations. Beyond that it might be necessary or useful to select the horizontal distance (distance in direction of the y axis) between individual radiating elements different from the vertical distance (distance in direction of the x axis).

Preferably on the back side of the back wall of the different embodiments a housing for a transceiver or similar is mounted. This housing can be reinforced at the fold (see for example 21.1). The coupling edges of the housing can be inserted into the fold. The power electronics can also be in the housing.

The antennas describe and shown are particularly suitable for the operation in the gigahertz frequency range, where the supply inputs are supplied with signals which have a center frequency which is greater than 1 GHz. The antennas are particularly suitable fur mobile telephony and other communication systems. As upper frequency limit, about 60 GHz can be considered. The invention is not limited however to an application in this frequency range.

The antenna housing according to the invention can take any planar three-dimensional form, as long as sufficient stability is ensured. In the figures 1A to 4 rectangular or square forms are shown. As presented in FIG. 6, the form can be also oval for example.

Due to the layered construction method and the materials used, the described antennas and particularly the group antennas are very compact and light. They can be manufactured relatively easily and at low costs, they are extremely stable and suitable to the deployment in difficult environments too.

The different elements of the individual embodiments can be combined depending upon need.

1. Antenna housing for a group antenna, the antenna housing comprising:
a wall comprising composite materials and a connecting area, the wall being designed as carrier of antenna elements of an antenna, said wall comprising means for mounting, in order to fasten the antenna housing on a pole or a building;
a radio-frequency- or high-frequency-suitable foam core comprising recesses for receiving at least one radiating element; and
a thin, hard, radio-frequency- or high-frequency-suitable radome, the radome being flexible and connectible like a cover with the connecting area of the wall, such that, the radome and the wall together comprise the antenna housing for the foam core, several radiating elements, and at least one circuit board to drive the radiating elements,
wherein the radome is backed by the foam core and said foam core stabilizes the radome.

2. Antenna housing according to claim 1,
means for exercising a contact pressure on one or more of the antenna elements, wherein the means are in a rear area of the antenna housing,

3. Antenna housing according to claim 1 wherein the wall further comprises at least one thermoplastically deformed plate.

4. Antenna housing according to claim 1, the wall further comprising a first layer and a second layer, wherein the first layer is deformed by deep-drawing or press forming.

5. Antenna housing according to claim 1, said means for mounting further comprising spline nuts or other fastening means, the spline nuts or other fastening means being mechanically anchored in wall in order to introduce forces of a suspension into the wall.

6. Antenna housings according to claim 1, further comprising:
one or more connecting devices to electrically connect between a control circuit disposed within the antenna housing and an external electronic device.

7. Antenna housing according to claim 1, wherein the connecting area is circumferential and the wall within the connecting area comprises a thermoplastic material to enable a welding, riveting, or gluing of the radome to the wall.

8. Antenna housing according to claim 7, wherein the radome is made of one or more foils in a forming tool.

9. Antenna housing according to claim 8, wherein an external side of the radome is water-repellant and/or ultra-violet-stabilized.

10. Antenna housing according to claim 9, wherein the radome comprises Tedlar® and/or Kynar®.

11. Antenna housing according to claim 10, wherein the radome has a thickness between 0.5 mm and 5 mm, preferably between 1 mm and 2 mm.

12. Antenna housing according to claim 1, the foam core further comprising a thermoplastic polymer, wherein the thermoplastic polymer is selected from the group consisting of polystyrene, copolymers of polystyrene, polyether polyurethane, polyester polyurethane, polypropylene, polyethylenes, polymethyl metacrylate, and polymethacrylimid.

13. Antenna housing according to claim 12, wherein the foam core is fiber-reinforced.

14. Antenna housing according to claim 13, wherein the foam core is made up of a multilayered structure or a multi-zone structure.

15. Antenna housing according to claim 14, wherein the foam core comprises a pressure resistant surface and/or is flame-retardantly modified.

16. Group antenna comprising the antenna housing of claim 1, the group antenna further comprising:
several three-dimensional radiating elements designed as dipole antennas, the radiating elements preferably being made as plastic injection molding parts wherein a surface of the radiating elements is metallized.

17. Group antenna according to claim 16, further comprising a circuit board with a control circuit.

18. Group antenna according to claim 17, wherein the control circuit comprises at least one radiating element and connecting area to receive the at least one radiating element and to provide an electrically conducting connection between the control circuit and at least one radiating element.

19. Group antenna according to claim 18, further comprising:
a further circuit board to be mechanically and electrically connected with the circuit board using plug connectors, wherein the further circuit board preferably comprises a calibration device or parts of a control circuit.

20. Group antenna according to claim 16, further comprising:
a foam bed to insert into the wall and to provide an essentially planar contact surface for the circuit board, wherein the foam bed preferably comprises recesses for cables, the cables to be connected to the circuit board.

21. Group antenna according to claim 16, further comprising:
at least one spring element to exercise a contact pressure on one or several of the antenna elements.

22. Group antenna according to claim 16, further comprising:
several three-dimensional radiating elements, the radiating elements to be installed in the antenna housing.

23. Antenna housing of claim 2, wherein the means comprise a spring element.

24. Antenna housing of claim 3, wherein the thermoplastically deformed plate comprises either polypropylene or polyamide.

25. Antenna housing of claim 6, wherein the one or more connecting devices comprise flange connectors.

26. Antenna housing of claim 13, wherein the fiber-reinforced foam core is glass-reinforced.
